(19) United States
(12) Patent Application Publication
(10) Pub. No.: US 2013/0100359 A1
(43) Pub. Date: Apr. 25, 2013

(54) DISPLAY DEVICE PACKAGING STRUCTURE, TELEVISION SET, AND DISPLAY DEVICE ASSEMBLY METHOD

(71) Applicant: Funai Electric Co., Ltd., Osaka (JP)

(72) Inventors: Akira YOKAWA, Osaka (JP); Nobuhiro MATSUTANI, Osaka (JP); Yuki KITA, Osaka (JP); Akihiro FUJIKAWA, Osaka (JP)

(73) Assignee: Funai Electric Co., Ltd., Osaka (JP)

(21) Appl. No.: 13/648,031

(22) Filed: Oct. 9, 2012

(30) Foreign Application Priority Data
Oct. 25, 2011 (JP) 2011-233868

(51) Int. Cl. B65D 85/30; B65B 69/00; H04N 5/64

(52) U.S. Cl. 348/836; 206/320; 29/592.1; 348/E05.128

(57) ABSTRACT

A display device packaging structure includes a first cushioning member. The first cushioning member is configured to be detachably attached to a device main body of a display device. The first cushioning member includes a bottom component that is configured to face with a display face of the device main body, a side wall component that is arranged relative to the bottom component such that the side wall component is configured to cover a side face portion of the device main body, and an access component that is disposed on the side wall component. The access component is configured to expose an attachment component of the device main body such that a stand of the display device is attachable to the attachment component of the device main body through the access component while the first cushioning member is attached to the device main body.

### CROSS-REFERENCE TO RELATED APPLICATIONS

This application claims priority to Japanese Patent Application No. 2011-233868 filed on Oct. 25, 2011, The entire disclosure of Japanese Patent Application No. 2011-233868 is hereby incorporated herein by reference.

### BACKGROUND

1. Field of the Invention

The present invention generally relates to a display device packaging structure. More specifically, the present invention relates to a display packaging structure for a display device. Furthermore, the present invention relates to a television set and a display device assembly method

2. Background Information

Conventionally, a packaging structure for a display device with a stand is known (see Japanese Laid-Open Patent Application Publication No. 2010-247889 (Patent Citation 1), for example).

In this packaging structure as illustrated in Patent Citation 1, a display device, an upper cushioning component and a lower cushioning component are housed in a packaging box. The display device includes a stand and a flat-panel device main body to the bottom of which is provided with an attachment component for the stand. The upper cushioning component has been fitted to the upper part of the device main body, while the lower cushioning component has been fitted to the lower part of the device main body. The device main body is housed in the packaging box in a state in which a display face has been laid down horizontally and facing down. The display device assembly method for this packaging structure is as follows. First, the upper face of the packaging box is opened and the stand is taken out. Next, inside the packaging box, the device main body is raised (i.e., stood up) so that the upper part of the device main body and the upper cushioning component, are disposed below and the bottom side (i.e., lower cushioning component) is disposed above. Then, the lower cushioning component is removed from the device main body. This exposes the attachment component on the bottom face of the device main body. Then, the removed lower cushioning component is placed in a specific orientation inside the packaging box. When the raised device main body is then lowered so that it returns to its original laid-down orientation, the device main body is supported in an inclined state so that it is closer to the lower cushioning component disposed inside the packaging box. As a result, the device main body is supported in an orientation in which the bottom face and the attachment component of the device main body face diagonally upward. The stand can be attached to the device main body in this state.

### SUMMARY

However, with this display device packaging structure discussed in Patent Literature 1, the user has to hold the device main body in an erect state during assembly while removing and installing the lower cushioning component, and then lay the device main body back down again. Since display devices (or device main bodies) have become markedly thinner and larger in recent years, so when a flat-panel device main body is raised up without its stand, the device main body is extremely unstable. If the device main body should fall over during assembly work, it may break, and in particular, even light scratches to the display face can affect its display quality. Therefore, it has been discovered that a problem with the above-mentioned display device packaging structure is that the display device is not adequately protected during assembly work.

One object of the present disclosure is to provide a display device packaging structure with which a display device can be adequately protected during assembly work.

In view of the state of the know technology, a display device packaging structure includes a first cushioning member. The first cushioning member is configured to be detachably attached to a device main body of a display device. The first cushioning member includes a bottom component that is configured to face with a display face of the device main body of the display device, a side wall component that is arranged relative to the bottom component such that the side wall component is configured to cover a side face portion of the device main body of the display device, and an access component that is disposed on the side wall component. The access component is configured to expose an attachment component of the device main body of the display device such that a stand of the display device is attachable to the attachment component of the device main body of the display device through the access component while the first cushioning member is attached to the device main body of the display device.

Other objects, features, aspects and advantages of the present disclosure will become apparent to those skilled in the art from the following detailed description, which, taken in conjunction with the annexed drawings, discloses selected embodiments of the display device packaging structure.

### BRIEF DESCRIPTION OF THE DRAWINGS

Referring now to the attached drawings which form a part of this original disclosure:

FIG. 1 is an exploded perspective view of a television set in accordance with a first embodiment;

FIG. 2 is a perspective view of the television set illustrated in FIG. 1, with front and rear cushioning components attached to a device main body of a liquid crystal television device;

FIG. 3 is a perspective view of the television set illustrated in FIG. 1, illustrating an assembling method for the liquid crystal television device, with a stand attached to the device main body;

FIG. 4 is a front perspective view of the liquid crystal television device;

FIG. 5 is a rear perspective view of the liquid crystal television device;

FIG. 6 is a top plan view of the liquid crystal television device in a state in which the front cushioning component is attached to the device main body while the liquid crystal television device being laid down on the front cushioning component;

FIG. 7 is an elevational view of the liquid crystal television device illustrated in FIG. 6, with the liquid crystal television device laid down on the front cushioning component;

FIG. 8 is an exploded perspective view of a television set in accordance with a second embodiment;

FIG. 9 is a perspective view of the television set illustrated in FIG. 8, with first to third cushioning components attached to a device main body of a liquid crystal television device;

FIG. 10 is a perspective view of the television set illustrated in FIG. 8, illustrating an assembling method for the liquid crystal television device, with a stand attached to the device main body;

FIG. 11 is a bottom plan view of the liquid crystal television device in a state in which the first to third cushioning components are attached to the device main body while the liquid crystal television device being laid down on the first and second cushioning components;

FIG. 12 is a top plan view of the liquid crystal television device in a state in which the first and second cushioning components are attached to the device main body, with the third cushioning component removed;

FIG. 13 is an elevational view of the liquid crystal television device illustrated in FIG. 12, with the liquid crystal television device laid down on the first and second cushioning components; and

FIG. 14 is a perspective view of a television set in accordance with a modified embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

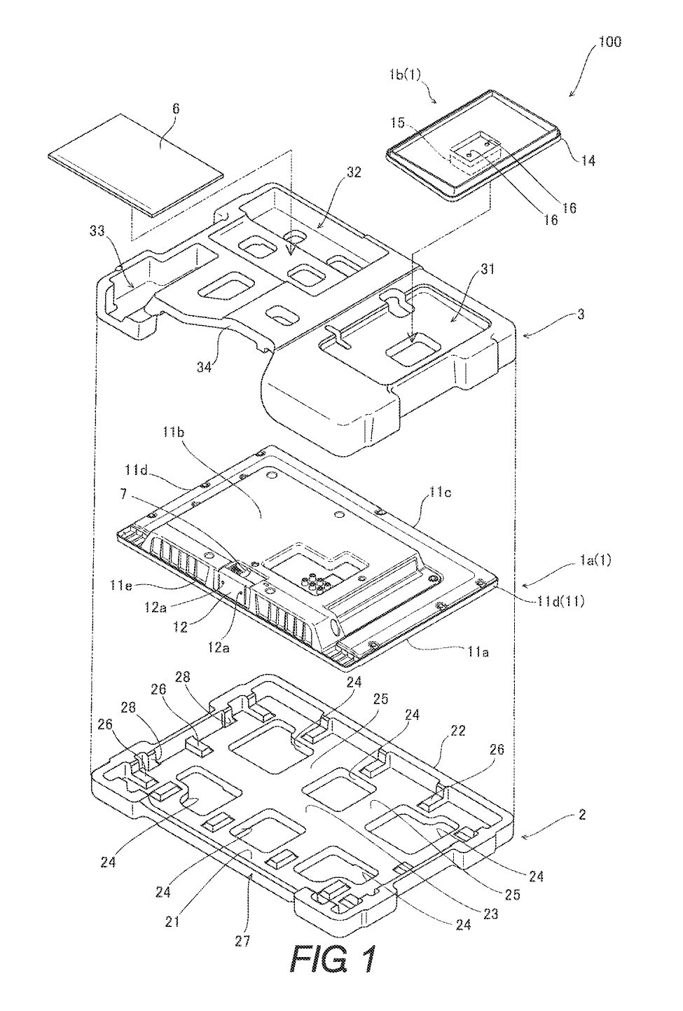

The configuration of a television set 100 pertaining to a first embodiment will be described through reference to FIGS. 1 to 7. In this first embodiment, an example will be described in which a “display device packaging structure” is applied to a packaging structure for a liquid crystal television device 1 in the television set 100.

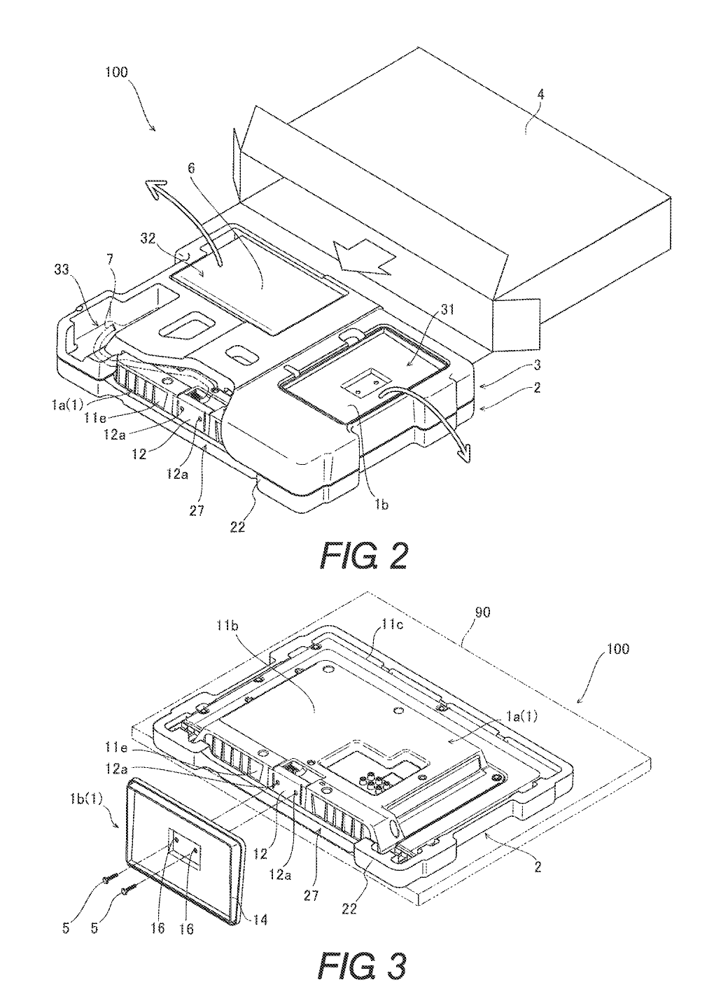

As shown in FIGS. 1 and 2, the television set 100 includes a liquid crystal television device 1, and front and rear cushioning components 2 and 3 that are made of foamed resin. The front cushioning component 2 is integrally formed as a one-piece, unitary member. The rear cushioning component 3 is integrally formed as a one-piece, unitary member. The liquid crystal television device 1, the front cushioning component 2, and the rear cushioning component 3 are packaged by being put into a packaging box 4. The liquid crystal television device 1 is an example of a “display device” and a “television device.” The front cushioning component 2 is an example of a “first cushioning member” and a “cushioning member,” while the rear cushioning component 3 is an example of a “second cushioning member.” The configuration of the liquid crystal television device 1 will be described first.

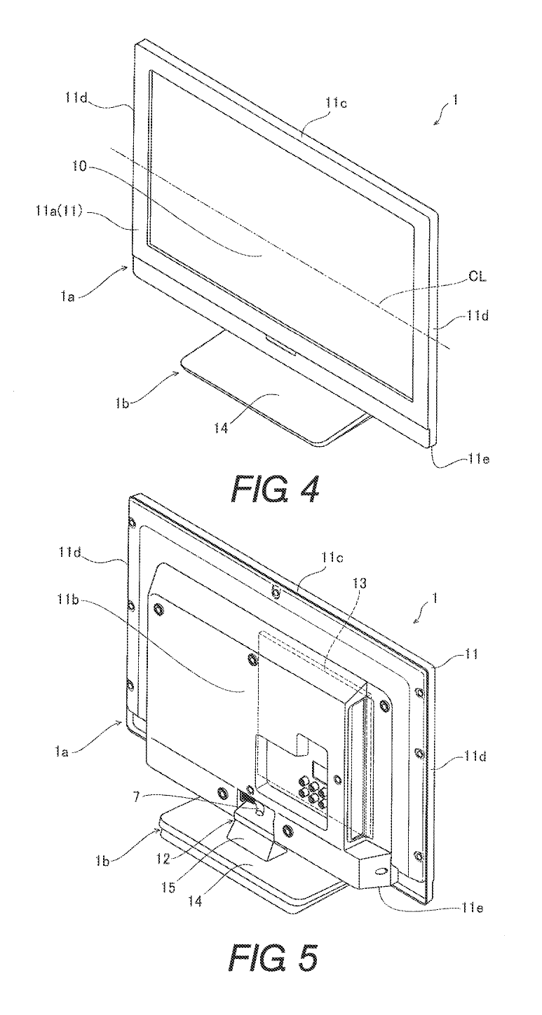

As shown in FIGS. 4 and 5, the liquid crystal television device 1 has a device main body 1a and a stand 1b. The stand 1b is attachable to the device main body 1a. The stand 1b is attached to and removed from the device main body 1a. The device main body 1a includes a liquid crystal module with a display face 10 (see FIG. 4), and a housing 11 in which the liquid crystal module is housed. The housing 11 has a front face 11a (see FIG. 4) in the form of a rectangular frame and surrounds and exposes the display face 10, a rear face 11b (see FIG. 5) that covers the liquid crystal module, a top face (e.g., upper face) 11c, a pair of lateral side faces 11d, and a bottom face 11e on which is formed an attachment component 12 (see FIG. 5) to which the stand 1b is attachable. In other words, the stand 1b is detachably attached to the attachment component 12 such that the stand 1b supports the device main body 1a. The device main body 1a has a rectangular shape as seen from the display face 10 side.

As shown in FIG. 5, a circuit board 13 for performing signal processing and supplying power to the entire device is built into the interior of the housing 11 on the rear face 11b side (see the broken line). The circuit board 13 has a tuner capable of receiving television broadcasts. The tuner of the circuit board 13 is connected to the liquid crystal module and a speaker (not shown). The video signal, which is part of the television broadcast signal (i.e., video signal and audio signal) received by an external antenna, is outputted to the liquid crystal module. The television broadcast is displayed on the display face 10, while the audio signal is outputted to the speaker. The circuit board 13 is an example of a “receiver.”

As shown in FIG. 1, the attachment component 12 is disposed on the bottom face 11e at the center of the bottom face 11e in a lengthwise direction (e.g., a first direction or horizontal direction) of the liquid crystal, television device 1. Two threaded holes 12a corresponding to through-holes 16 in the stand 1b (discussed below) are formed in the attachment component 12.

As shown in FIGS. 4 and 5, the stand 1b includes a base component 14 that is inclined so that its height (i.e., thickness) decreases toward the front, and a support component 15 (see FIG. 5) that protrudes upward from the base component 14. As shown in FIG. 3, two through-holes 16 that pass from the rear face (i.e., a bottom face) of the base component 14 through to the top face of the support component 15 are formed in the stand 1b. Attachment screws 5 are threaded into the threaded holes 12a of the attachment component 12 through the through-holes 16 in the stand lb to removably attach the stand 1b to the bottom face 11e of the housing 11 of the device main body 1a at the attachment component 12.

The packaging structure of the liquid crystal television device 1 will now be described.

As shown in FIG. 1, the front cushioning component 2 is removably disposed on the display face 10 side (i.e., the front face 11a side) of the device main body 1a. The front cushioning component 2 integrally includes a bottom component 21 that covers the display face 10, and a side wall component 22 provided around the edges of the bottom component 21. The bottom component 21 in plan view has a rectangular shape corresponding to the external shape (i.e., rectangular) of the housing 11 of the device main body 1a of the liquid crystal television device 1. Also, as shown in. FIG. 3, the side wall component 22 protrudes from the edges of the bottom component 21 to the rear face 11b side of the device main body 1a. The side wall component 22 is formed so as to surround the entire device main body 1a (i.e., the top face 11c, the pair of lateral side faces 11d, and the bottom face 11e). Accordingly, the front cushioning component 2 is formed in a concave shape that covers the display face 10 (i.e., the front face 11a) of the rectangular device main body 1a and the four sides on the display face 10 side (i.e., the top face 11c, the pair of lateral side faces 11d, and the bottom face 11e), and is configured so that the front face 11a side of the device main body 1a fits into the front cushioning component 2. Accordingly, the front cushioning component 2 is detachably attached to the device main body 1a. The front cushioning component 2 includes the bottom component 21 that faces with the display face 10 and the side wall component 22 that is arranged relative to the bottom component 21 such that the side wall component 22 covers a side face portion (e.g., the top face 11c, the pair of lateral side faces 11d, and the bottom face 11e) of the device main body 1a. Furthermore, the front cushioning component is configured such that the stand 1b is attachable to the attachment component 12 of the device main body 1a while the front cushioning component 2 is attached to the device main body 1a, as described below in detail.

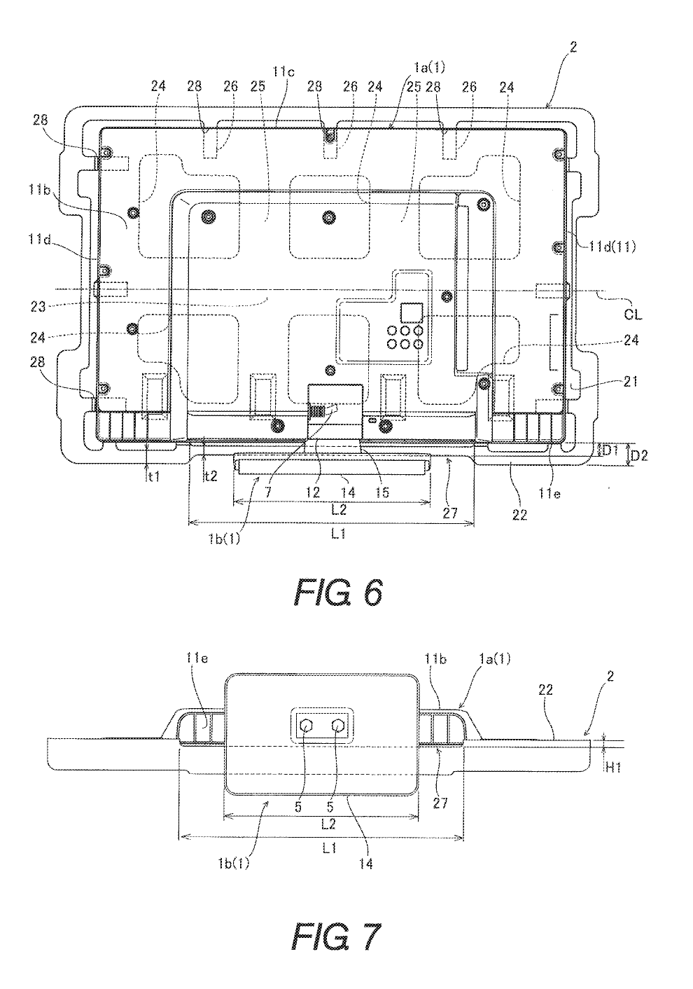

As shown in FIG. 1, the bottom component 21 has a straight center part 23 that traverses the center in the lengthwise direction, and six holes 24 that are provided three each on both sides of the center part 23 in the short-side direction. As shown by the broken line in FIG. 6, the center part 23 is formed so as to cover the center of the display face 10 over and along substantially the entire length of the display face 10 along a center line CL extending in the lengthwise direction of the rectangular device main body 1a.

As shown in FIGS. 1 and 6, the six holes 24 are disposed in regions on the display face side of the bottom component 21 excluding the center part 23 (e.g., at locations other than the center part 23). The holes 24 are separated from one another by crosspieces 25 extending in the short-side direction from the center part 23. The holes 24 are disposed so as to be isolated from the edges (i.e., the side wall component 22) of the bottom component 21. Also, a plurality of ribs 26 that are flat on top and that rise up from the bottom component 21 are formed on the bottom component 21. These ribs 26 are each disposed at positions that come into contact with the frame-like front face 11a of the housing 11 in a state in which the front cushioning component 2 is attached to the device main body 1a, thereby preventing the display face 10 from touching the front cushioning component 2.

In this embodiment, as shown in FIGS. 3 and 7, the side wall component 22 is formed so as to cover the bottom face 11e of the housing 11 of the device main body 1a corresponding to the attachment component 12, while exposing the attachment component 12 of the device main body 1a. More specifically, the front cushioning component 2 has a recess 27 (e.g., an access component) that is disposed on and formed in the side wall component 22. In particular, the recess 27 is arranged relative to the side wall component 22 such that the recess 27 exposes the attachment component 12. The recess 27 exposes the attachment component 12 such that the stand 1b is attachable to the attachment component 12 through the recess 27 while the front cushioning component 2 is attached to the device main body 1a. Here, the side wall component 22 is formed so as to extend in the lengthwise direction over and along substantially the entire length of the bottom face 11e of the device main body 1a, while the recess 27 is formed over a range of a length L1 centered on the position where the attachment component 12 is disposed. As shown in FIGS. 6 and 7, the length L1 of the recess 27 in the lengthwise direction is greater than the length L2 of the corresponding stand 1b. In this embodiment, as shown in FIG. 3, the front cushioning component 2 is configured such that the stand 1b can be attached to the attachment component 12 exposed from the side wall component 22 (i.e., the recess 27) in a state in which the front cushioning component 2 is attached to the device main body 1a and in an orientation in which the device main body 1a has been laid down so that the display face 10 is opposite an installation surface 90 with the front cushioning component 2 in between.

The recess 27 is formed such that the protrusion height of the side wall component 22 is less than that of the portion other than the recess 27. In other words, the side wall component 22 has a smaller protrusion height at a portion where the recess 27 is located than at a portion other than the portion where the recess 27 is located. Specifically, as shown in FIG. 7, using the maximum height of the side wall component 22 (e.g., the protrusion height of the portion other than the recess 27) as a reference, the protrusion height of the side wall component 22 at the recess 27 is formed to be lower by H1.

Also, the recess 27 is formed such that the wall thickness of the side wall component 22 is less than that of the portion other than the recess 27, In other words, the side wall component 22 has a smaller wall thickness at a portion where the recess 27 is located than at a portion other than the portion where the recess 27 is located. Specifically, as shown in FIG. 6, the side wall component 22 disposed on the bottom face 11e side of the device main body 1a has a thickness t1 at the portion other than the recess 27, while the side wall component 22 has a thickness t2 that is less than the thickness t1 at the position where the recess 27 is formed. Furthermore, the recess 27 is formed so that the side wall component 22 is recessed inward, and is configured such that the side wall component 22 is closer to the bottom face 11e of the device main body 1a. Therefore, in plan view, the distance D1 from the bottom face 11e of the device main body 1a at the recess 27 (i.e., at the attachment component 12) to the outer surface of the side wall component 22 is less than the distance D2 from the bottom face 11e of the device main body 1a at the portion other than the recess 27 to the outer surface of the side wall component 22. These dimensions of the recess 27 are set by taking into account the convenience of the user so that the side wall component 22 of the front cushioning component 2 and the stand 1b attached to the device main body 1a at the attachment component 12 do not interfere in a state in which the front cushioning component 2 is attached to the device main body 1a.

A plurality of ribs 28 that are flat on top and protrude inward are also provided to the side wall component 22, just as to the bottom component 21. As shown in FIG. 6, the ribs 28 of the side wall component 22 are each disposed at a position that comes into contact with the side faces of the housing 11 (i.e., the top face 11c, the lateral side faces 11d, and the bottom face 11e) in a state in which the front cushioning component 2 is attached to the device main body 1a.

As shown in FIG. 1, the rear cushioning component 3 is removably disposed on the rear face 11b side of the device main body 1a (i.e., the opposite side from the display face 10), and is formed so as to cover substantially the entire rear face 11b of the device main body 1a. Although not shown in the drawings, the inner face of the rear cushioning component 3 is formed in a concave shape that corresponds to the external shape of the rear face 11b side of the device main body 1a, and the rear face 11b side of the device main body 1a fits into the rear cushioning component 3 (see FIG. 2).

Also, the rear cushioning component 3 has three concave compartments 31, 32, and 33 on its top face (i.e., the outer surface on the opposite side from the side on which the device main body 1a is disposed).

The compartment 31 is configured so as to be capable of holding the stand 1b, and is formed in a concave shape that corresponds to the stand 1b (i.e., the base component 14 and the support component 15). Consequently, the stand 1b and the device main body 1a are both packaged inside the packaging box 4, instead of being packaged separately. Thus, fewer members are needed for packaging. The compartment 32 is configured so as to be capable of holding an instruction manual or other such booklet 6 and any accessories, such as a remote control. The compartment 33 is formed so as to be continuous with a cutout 34, and is configured so as to be capable of holding a power cable 7. The cutout 34 is formed in order to pull out the power cable 7 provided on the upper side (i.e., the top face 11c side) of the attachment component 12 of the device main body 1a to the compartment 33, as indicated by the two-dot chain line in FIG. 2.

As shown in FIG. 2, with the above configuration, the front cushioning component 2 and the rear cushioning component 3 are attached to the device main body 1a of the liquid crystal television device 1, the stand 1b, the booklet 6, the power cable 7 and so forth are held in the compartments 31, 32 and 33 of the rear cushioning component 3, respectively, and these are put inside the packaging box 4, thereby constituting the complete television set 100.

Next, the assembly method for the liquid crystal television device 1 of the television set 100 (i.e., a stand attachment method) will be described through reference to FIGS. 2 to 4.

The assembly of the liquid crystal television device 1 is usually carried out by the user who purchases the television set 100. First, as shown in FIG. 2, the packaging box 4 is opened. Then, the liquid crystal television device 1 is taken out of the packaging box 4 in a state in which the front cushioning component 2 and the rear cushioning component 3 are attached to the device main body 1a. After this, the stand 1b and the instruction manual or other booklet 6 are taken out of the compartments 31 and 32 of the rear cushioning component 3.

Next, as shown in FIG. 3, the device main body 1a of the liquid crystal television device 1 is placed on the installation surface 90 such that the display face 10 of the device main body 1a is opposite the installation surface 90 with the front cushioning component 2 in between. Then, the rear cushioning component 3 is taken out in a state in which the front cushioning component 2 is attached and in an orientation in which the device main body 1a has been laid down so that the display face 10 (see FIG. 4) is opposite the installation surface 90 with the front cushioning component 2 in between. If the up and down directions or the box opening method is indicated on the packaging box 4 (see FIG. 2), then at the point of removal from the packaging box 4, the device main body 1a can be disposed on the installation surface 90 in a laid-down orientation so that the display face 10 is opposite the installation surface 90 with the front cushioning component 2 in between.

Then, the stand 1b that has been removed from the rear cushioning component

3 is attached to the attachment component 12 exposed from the recess 27 of the side wall component 22 of the front cushioning component 2 through the recess 27 while the device main body 1a still laid down and the front cushioning component 2 is attached to the device main body 1a. Here, as shown in FIG. 3, the attachment screws 5 are threaded into the threaded holes 12a of the attachment component 12 via the through-holes 16, while the device main body 1a with the front cushioning component 2 is still on the installation surface 90, such as a table and the like. This attaches the stand 1b to the attachment component 12 on the bottom face 11e of the device main body 1a.

Once the assembly of the liquid crystal television device 1 (i.e., an attachment of the stand 1b) is complete, the front cushioning component 2 is removed from the device main body 1a, and the stand 1b of the liquid crystal television device 1 is placed on the installation surface 90 as shown in FIG. 4. This completes the assembly of the liquid crystal television device 1 from the television set 100.

In this embodiment, as discussed above, the configuration is such that the stand 1b is attached to the attachment component 12 exposed from the side wall component 22 in a state in which the front cushioning component 2 is attached to the device main body 1a and in an orientation in which the device main body 1a has been laid down so that the display face 10 is opposite the installation surface 90 with the front cushioning component 2 in between. This allows assembly (i.e., attachment of the stand 1b) to be performed in an orientation in which the device main body 1a has been laid down, without having to raise (or stand up) the device main body 1a. This prevents the device main body 1a from falling over during assembly work. Also, during assembly, the stand 1b can be attached in a state in which the front cushioning component 2 attached to the device main body 1a is interposed between the display face 10 and the installation surface 90. Thus, the device main body 1a, and particularly the display face 10, can be reliably protected by the front cushioning component 2. Consequently, with the television set 100 of this embodiment, the device main body 1a of the liquid crystal television device 1 can be adequately protected during assembly work.

Also, in this embodiment, as discussed above, the attachment component 12 is disposed on the bottom face 11e of the device main body 1a, and the recess 27 that exposes the attachment component 12 is provided to the side wall component 22 of the front cushioning component 2. Thus, the attachment component 12 can be exposed from the side wall component 22 of the front cushioning component 2 even with a structure in which the attachment component 12 is disposed on the bottom face 11e of the device main body 1a.

Also, in this embodiment, as discussed above, the side wall component 22 is formed so as to protrude to the rear face 11b side over the entire length of the bottom face 11e of the device main body 1a. The protrusion height of the side wall component 22 at the formation position of the recess 27 is formed to be lower by H1 than the portion other than the recess 27. Thus, the protrusion height of the side wall component 22 can be increased relatively at the portion other than the recess 27. Therefore, the portion other than the attachment component 12 of the bottom face 11e can be adequately protected during the attachment of the stand 1b.

Also, in this embodiment, as discussed above, the thickness t2 of the side wall component 22 at the position where the recess 27 is formed is less than the thickness t1 of the portion other than the recess 27. If just the position within the side wall component 22 where the recess 27 is formed (which is necessary for attaching the stand 1b) is made thinner, then the work of attaching the stand 1b will be easier, and the portion other than the attachment component 12 of the bottom face 11e of the device main body 1a can be adequately protected.

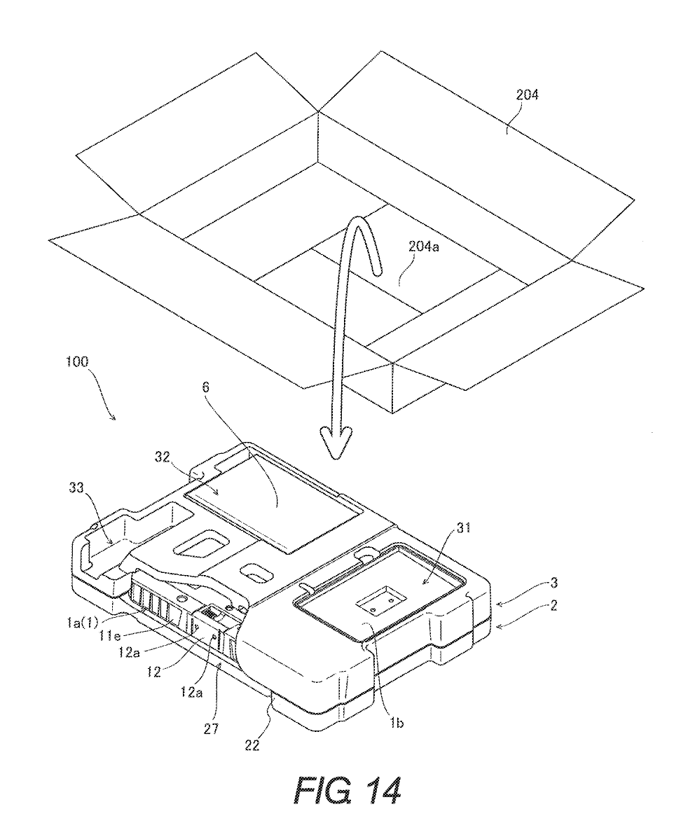

Also, in this embodiment, as discussed above, the center part 23 is formed in the front cushioning component 2 so as to cover the center of the display face 10 over the entire length of the display face 10 and along the center line CL. Even if the device main body 1a to which the front cushioning component 2 has been attached should accidentally be placed on some object, such as an attachment screw, for example, over the installation surface, the display face 10 can still be reliably protected by the center part 23. Also, when the packaging box 4 is being opened, the display face 10 can be effectively protected by the center part 23 even if the user happens to use a box cutter or other such cutting device to open the package from the display face 10 side (as shown in FIG. 14, the center of the bottom face 204a on the display face 10 side of the packaging box 204 is often cut in the lengthwise direction), for example.

Also, in this embodiment, as discussed above, the front cushioning component 2 is formed so as to cover the display face 10, and a plurality of (six in this embodiment) holes 24 are formed in the regions on the display face 10 side excluding the center part 23. Thus, the display face 10 is effectively protected by the front cushioning component 2, while the overall packaging structure of the liquid crystal television device 1 (i.e., the entire television set 100) will be more lightweight and less material will be consumed.

Also, in this embodiment, as discussed above, the configuration is such that the front cushioning component 2, which has the side wall component 22 and covers the display face 10 side of the device main body 1a, and the rear cushioning component 3, which is attached on the rear face 11b of the device main body 1a, are provided. The stand 1b is attached to the attachment component 12 exposed from the side wall component 22 of the front cushioning component 2 in a state in which the rear cushioning component 3 is attached, without having to remove the front cushioning component 2. Thus, in the packaged state, the liquid crystal television device 1 (i.e., the device main body 1a) can be even more reliably protected by the front cushioning component 2 and the rear cushioning component 3. Also, during assembly work, since the display face 10 of the device main body 1a is disposed on the front cushioning component 2, which is itself disposed on the installation surface 90, the display face 10 can be more reliably prevented from being scratched during assembly work.

Also, in this embodiment, as discussed above, the front cushioning component 2 is formed so as to cover the four sides on the display face 10 side of the rectangular device main body 1a. Since the four sides on the display face 10 side are covered by the front cushioning component 2, the front face 11a including the edges (or sides) of the device main body 1a (everything on the display face 10 side) can be effectively protected.

### Second Embodiment

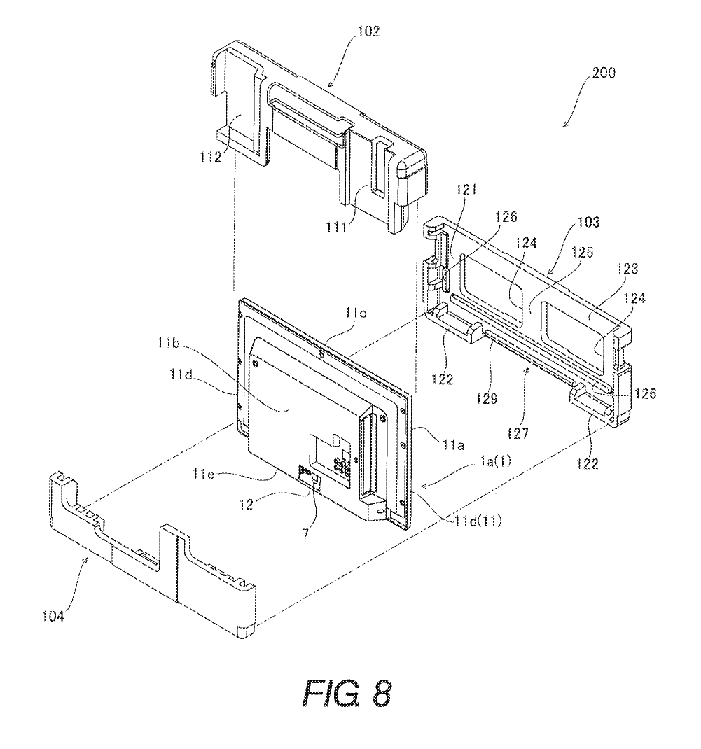

Referring now to FIGS. 8 to 13, a television set 200 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. In this embodiment, an example will be described in which three cushioning components are used, as opposed to the first embodiment above in which only two cushioning components (i.e., the front cushioning component 2 and the rear cushioning component 3) are used. In this embodiment, the configuration of the liquid crystal television device 1 is the same as in the first embodiment above, so the same reference numerals will be given and detailed descriptions will be omitted for the sake of brevity.

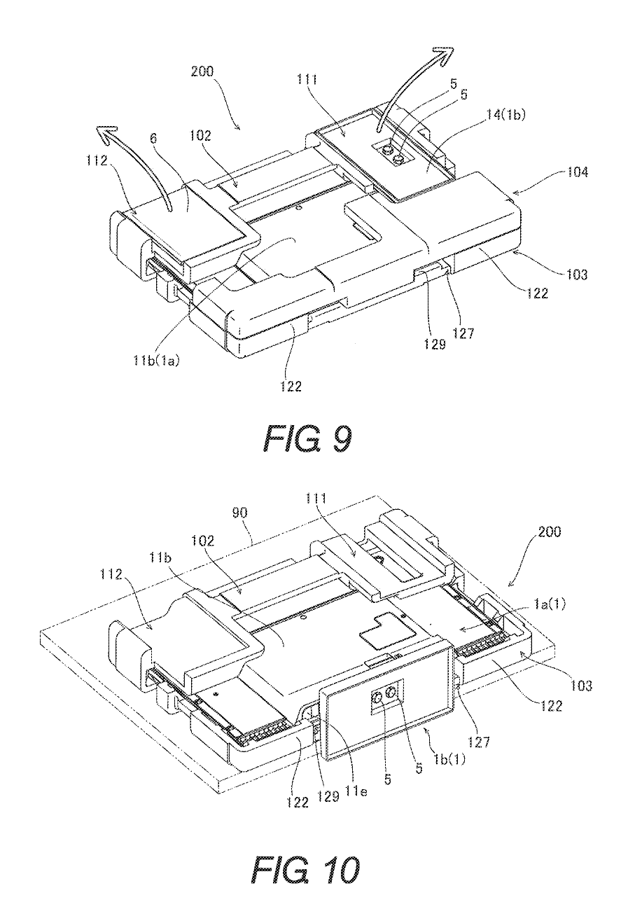

As shown in FIGS. 8 and 9, the television set 200 includes the liquid crystal television device 1, and first, second and third cushioning components 102, 103 and 104. The first, second and third cushioning components 102, 103 and 104 are configured such that the stand 1b of the liquid crystal television device 1 is attachable to the attachment component 12 of the device main body 1a while the third cushioning component 104 is removed from the device main body 1a and the first and second cushioning components 102 and 103 are attached to the device main body 1a. The first cushioning component 102 is integrally formed as a one-piece, unitary member. The second cushioning component 103 is integrally formed as a one-piece, unitary member. The third cushioning component 104 is integrally formed as a one-piece, unitary member. The first cushioning component 102 is attached to the upper part of the device main body 1a on the top face 11c side. The second cushioning component 103 is attached to and disposed on the display face 10 side (i.e., the front face 11a side) of the lower part of the device main body 1a on the bottom face 11e side. The third cushioning component 104 is attached on the rear face 11b side of the lower part of the device main body 1a. As shown in FIG. 10, the configuration is such that the stand 1b can be attached to the attachment component 12 exposed from a side wall component 129 (discussed below) of the second cushioning component 103 in a state in which the third cushioning component 104 is removed, without having to remove the first cushioning component 102 and the second cushioning component 103. The first cushioning component 102 and the second cushioning component 103 are examples of a “first cushioning member,” while the third cushioning component 104 is an example of a “second cushioning member.”

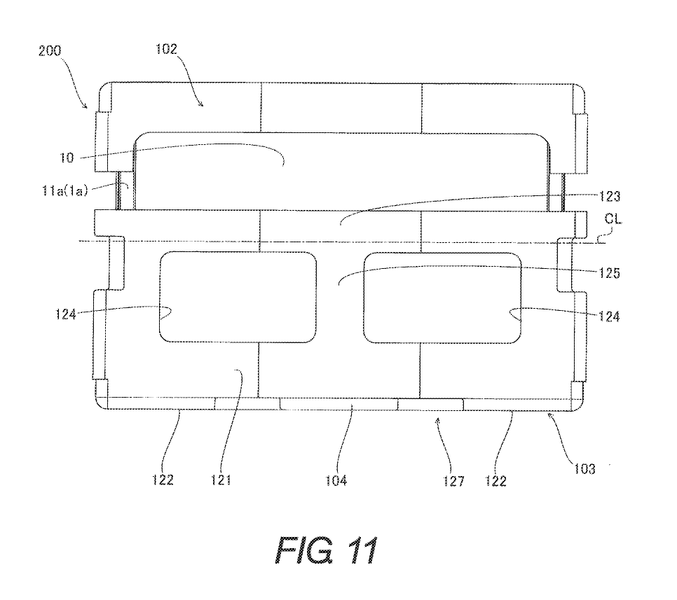

As shown in FIGS. 8 and 9, the first cushioning component 102 is formed to correspond to the external shape of the upper part (i.e., the top face 11c side portion) of housing 11 of the device main body 1a. The first cushioning component 102 is configured so as to surround the upper part of the device main body 1a from the display face 10 side (i.e., the front face 11a side) and the rear face 11b side. Therefore, the first cushioning component 102 is attached so that the top face 11c side of the device main body 1a is fitted into the first cushioning component 102. The first cushioning component 102 is formed so as to cover the entire top face 11c of the device main body 1a and the upper portions of the front face 11a (see FIG. 11), the rear face 11b, and the lateral side faces 11d.

As shown in FIGS. 9 and 10, a compartment 111 for holding the stand 1b, and a compartment 112 that can hold a booklet 6 or the like are formed on the outer surface on the rear face 11b side of the first cushioning component 102.

As shown in FIG. 8, the second cushioning component 103 integrally includes a bottom component 121 that covers the display face 10 from the center to the lower part (i.e., the bottom face 11e side), and side wall components 122 and 129 provided along the peripheral edges of the bottom component 121. The second cushioning component 103 is formed in a concave shape that covers the display face 10 (i.e., the front face 11a) of the rectangular device main body 1a and three sides on the display face 10 side (i.e., the pair of lateral side faces 11d and the bottom face 11e). As shown in FIG. 11, the second cushioning component 103 is formed so that in plan view it covers approximately two-thirds of the region on the front face 11a side of the device main body 1a. Therefore, in this embodiment, the first cushioning component 102 and the second cushioning component 103 are configured so as to cover substantially the entire four sides of the device main body 1a on the display face 10 side of the device main body 1a.

As shown in FIGS. 8 and 11, the bottom component 121 has a center part 123 and two holes 124. The center part 123 is formed so as to cover the center of the display face 10 over the entire length of the device main body 1a along the center line CL extending in the lengthwise direction of the rectangular device main body 1a. The two holes 124 are provided on the bottom face 11e side with respect to the center part 123. The two holes 124 are separated by crosspieces 125 extending in the short-side direction of the device main body 1a. As shown in FIG. 8, a plurality of ribs 126 that are flat on top and that rise up from the bottom component 121 are formed on the bottom component 121.

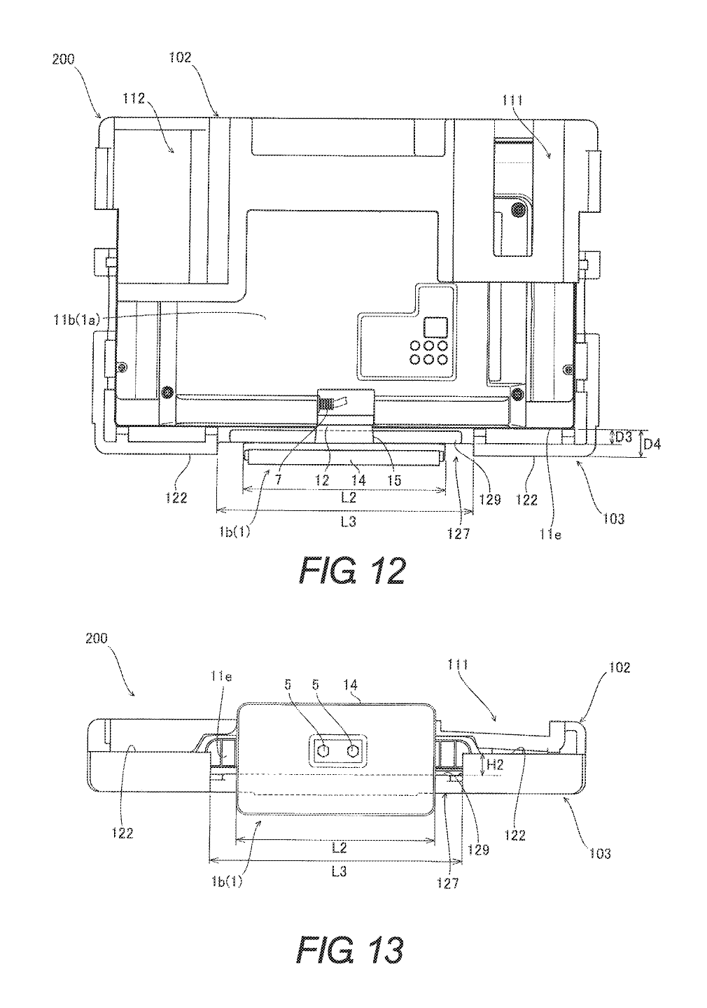

In this embodiment, as shown in FIGS. 8 and 12, the recess 127 is formed by removing (or cutting out) a region of the side wall component 122 corresponding to the attachment component 12 of the device main body 1a. The recess 127 is formed over a range of a length L3 in the lengthwise direction that is longer than the length L2 of the stand 1b in the lengthwise direction, using the position where the attachment component 12 is disposed as the center. The side wall component 129, which extends over substantially the entire length of the recess 127, is formed at the position where the recess 127 is formed. Accordingly, as shown in FIG. 12, the side wall component 122 and the side wall component 129 are formed so as to extend over substantially the entire length of the device main body 1a on the bottom face 11e side of the device main body 1a to which the attachment component 12 is provided.

The side wall component 129 formed at the recess 127 is formed so that its protrusion height is less than that of the side wall component 122. Specifically, as shown in FIG. 13, using the maximum height of the side wall component 122 as a reference, the protrusion height of the side wall component 129 formed at the recess 127 is formed to be lower by H2. Consequently, in this embodiment, the second cushioning component 103 is formed such that the side wall component 122 covers the bottom face 11e of the device main body 1a corresponding to the attachment component 12, while the attachment component 12 of the device main body 1a is exposed from the side wall component 129 at the recess 127 in the side wall component 122.

As shown in FIG. 12, the recess 127 is configured such that the side wall component 129 is disposed at a position that is shifted inward more than the side wall component 122, while the side wall component 129 is closer to the bottom face 11e of the device main body 1a than the side wall component 122. Therefore, in plan view, the distance D3 from the bottom face 11e (i.e., the attachment component 12) of the device main body 1a at the recess 127 to the outer surface of the side wall component 129 is less than the distance D4 from the bottom face 11e to the outer surface of the side wall component 122. These dimensions of the recess 127 (i.e., the side wall component 129) are set so that the side wall component 129 of the second cushioning component 103 and the stand 1b attached to the attachment component 12 of the device main body 1a do not interfere in a state in which the second cushioning component 103 is attached to the device main body 1a.

As shown in FIGS. 8 and 9, the third cushioning component 104 is formed so as to cover the lower part (i.e., the bottom face 11e side) of the rear face 11b of the device main body 1a. The third cushioning component 104 is disposed on the rear face 11b side of the lower part of the device main body 1a. Although not shown in the drawings, the third cushioning component 104 is configured such that its the inner face is formed in a concave shape that corresponds to the external shape of the rear face 11b side of the housing 11 of the device main body 1a, and the lower part of the rear face 11b side of the device main body 1a fits into the third cushioning component 104 (see FIG. 2). As shown in FIG. 9, the third cushioning component 104 is formed so as to cover the lower part of the rear face 11b of the device main body 1a, and to cover that a portion of the bottom face 11e of the device main body 1a that is on the rear face 11b side exposed from the second cushioning component 103.

Next, the assembly method for the liquid crystal television device 1 of the television set 200 (i.e., a stand attachment method) will be described through reference to FIGS. 2, 9, and 10.

First, as shown in FIG. 9, the packaging box 4 (see FIG. 2) is opened. Then, the liquid crystal television device 1 is taken out of the packaging box 4 in a state in which the first, second and third cushioning components 102, 103 and 104 are attached to the device main body 1a. After this, the stand 1b and the instruction manual or other booklet 6 are taken out of the compartments 111 and 112 of the first cushioning component 102.

Next, as shown in FIG. 10, the device main body 1a of the liquid crystal television device 1 is placed on the installation surface 90 such that the display face 10 of the device main body 1a is opposite the installation surface 90 with the second cushioning component 103 and the front face 11a side portion of the first cushioning component 102 in between. Then, the third cushioning component 104 is removed from the rear face 11b in a state in which the first cushioning component 102 and the second cushioning component 103 are attached and in an orientation in which the device main body 1a has been laid down so that the display face 10 is opposite the installation surface 90 with the second cushioning component 103 and the front face 11a side portion of the first cushioning component 102 in between.

Then, while the device main body 1a is still laid down, the stand 1b that has been removed from the first cushioning component 102 is attached to the attachment component 12 exposed from the recess 127 of the side wall component 129 of the second cushioning component 103. Furthermore, the attachment screws 5 are threaded into the threaded holes 12a of the attachment component 12 via the through-holes 16, while the device main body 1a is still on the installation surface 90. Consequently, as shown in FIG. 10, the stand 1b is attached to the attachment component 12 on the bottom face 11e of the device main body 1a.

Once the assembly of the liquid crystal television device 1 (i.e., the attachment of the stand 1b) is complete, the second cushioning component 103 is removed from the device main body 1a, the stand 1b of the liquid crystal television device 1 is placed on the installation surface 90 as shown in FIG. 4, and finally the first cushioning component 102 is removed from the device main body 1a. This completes the assembly of the liquid crystal television device 1 from the television set 200.

In this embodiment, as discussed above, the configuration is such that the stand 1b is attached to the attachment component 12 exposed from the side wall component 129 in a state in which the first cushioning component 102 and the second cushioning component. 103 are attached and in an orientation in which the device main body 1a has been laid down so that the display face 10 is opposite the installation surface 90 with the first cushioning component 102 and the second cushioning component 103 in between. Thus, assembly (i.e., attachment of the stand 1b) can be performed in an orientation in which the device main body 1a has been laid down, without having to raise (or stand up) the device main body 1a. This prevents the device main body 1a from falling over during assembly work. Also, during assembly, the stand 1b can be attached in a state in which the first cushioning component 102 and the second cushioning component 103 attached to the device main body 1a are interposed between the display face 10 and the installation surface 90. Thus, the device main body 1a, and particularly the display face 10, can be reliably protected by the first cushioning component 102 and the second cushioning component 103, Consequently, with the television set 200 of this embodiment, the device main body 1a of the liquid crystal television device 1 can be adequately protected during assembly work.

Also, in this embodiment, as discussed above, the first cushioning component 102 that surrounds the upper part of the device main body 1a from the display face 10 side and the rear face 11b side, the second cushioning component 103 provided on the display face 10 side of the lower part of the device main body 1a and having the side wall components 122 and 129, and the third cushioning component 104 provided on the rear face 11b side of the lower part of the device main body 1a are provided. The stand 1b can be attached to the attachment component 12 exposed from the side wall component 129 (i.e., the recess 127) of the second cushioning component 103 in a state in which the third cushioning component 104 has been removed, without having to remove the first cushioning component 102 and the second cushioning component 103. Thus, assembly work can be performed with the display face 10 of the device main body 1a still protected by the first cushioning component 102 and the second cushioning component 103. Also, the cushioning component is divided into the first cushioning component 102, the second cushioning component 103, and the third cushioning component 104. Thus, the individual cushioning components can be prevented from becoming larger, and the cushioning components can be easily formed. This allows larger display devices to be accommodated.

The other effects of this embodiment are the same as those of the first embodiment above,

The embodiments disclosed herein are in all respects examples, and should not be considered as being limiting for the present invention. The scope of the present invention is indicated by the patent claims and not by the above description of embodiments, and all modifications within a meaning and scope that are equivalent to the patent claims are further included.

For example, in the first and second embodiments above, a television set having a liquid crystal television device is discussed as an example of a television device and a display device. However, the present disclosure is not limited to this. The present disclosure can also be applied to a television set having a television device other than a liquid crystal television device. Also, in the first and second embodiments above, a packaging structure for a liquid crystal television device is discussed. However, the present disclosure is not limited to this. The present disclosure can also be applied to a packaging structure for a display device other than a television device, such as a personal computer monitor or the like.

Also, in the first embodiment above, an example was given of using two cushioning components, namely, the front cushioning component 2 and the rear cushioning component 3, while in the second embodiment above, an example was given of using three cushioning components, namely, the first to third cushioning components 102 to 104. However, the present disclosure is not limited to this. Specifically, the number of cushioning components used can be one, or can be four or more.

Also, in the first and second embodiments above, the attachment component 12 for the stand 1b is disposed on the bottom face 11e of the housing 11 of the device main body 1a. Furthermore, an example was given of providing the front cushioning component 2 (or the second cushioning component 103) having a side wall component that covered the bottom face 11 e of the device main body 1a as an example of the first cushioning member. However, but the present disclosure is not limited to this. With the present disclosure, an attachment component can be disposed on the rear face 11b side of the device main body 1a. In this case, a side wall component of a first cushioning member can be formed so as to cover the rear face 11b of the device main body 1a while exposing the attachment component through the side wall component.

Also, in the first and second embodiments above, an example was given of providing a center part to the front cushioning component 2 (or the second cushioning component 103) as an example of the first cushioning member. However, the present disclosure is not limited to this. With the present disclosure, the center part need not be provided.

Also, in the first and second embodiments above, an example was given of providing six holes to the front cushioning component 2 (or two holes to the second cushioning component 103) as an example of the first cushioning member. However, the present disclosure is not limited to this. No holes can be provided with the present disclosure. Also, if holes are provided, the number can be from three to five, or can be seven or more.

Also, in the first embodiment above, an example was given of forming the device main body 1a in a rectangular shape as seen from the display face 10 side, and forming it so that the front cushioning component 2, as an example of the first cushioning member, covers the four sides of the device main body 1a on the display face 10 side. However, the present disclosure is not limited to this. With the present disclosure, the side wall component should cover at least a side face (or a side) where the attachment component 12 is disposed. The front cushioning component 2 need not cover all four sides of the device main body 1a on the display face 10 side. Also, the device main body 1a need not have a rectangular shape.

Also, in the first embodiment above, an example was given of a configuration in which the stand 1b could be attached in a state in which the rear cushioning component 3 is removed, without removing the front cushioning component 2 from the device main body 1a. However, the present disclosure is not limited to this. With the present disclosure, the configuration can be such that the stand 1b is attached in a state in which the front cushioning component 2 and the rear cushioning component 3 are both attached. In this case, the configuration can be such that the attachment component 12 is also exposed from the rear cushioning component 3, and the rear cushioning component 3 is formed so that it does not interfere with the stand 1b during stand attachment.

Also, in the first embodiment above, an example was given of a configuration in which the device main body 1a to which the front cushioning component 2 and the rear cushioning component 3 are attached is removed from a side face of the packaging box 4. However, the present disclosure is not limited to this. For example, as in the modification example shown in FIG. 14, the configuration can be such that the device main body 1a is removed from the top face of the packaging box 204. Furthermore, the configuration can be such that the packaging box is opened from any side face.

Also, in the first and second embodiments above, an example was given of using a cushioning component made of a foamed resin. However, the present disclosure is not limited to this. For example, a cushioning component made of molded pulp can be used. Furthermore, a cushioning component made of some material other than foamed resin or molded pulp can be used.

With the present disclosure, the display device packaging structure for a display device includes a first cushioning member. The display device has a device main body and a stand. The device main body has a display face and an attachment component to which the stand can be attached. The stand can be attached to and removed from the attachment component, and supports the device main body. The first cushioning member is provided attachably to and removably from the device main body, and includes a side wall component that covers a side face portion of the device main body corresponding to the attachment component while exposing the attachment component of the device main body. The display device packaging structure is configured such that the attachment component exposed from the side wall component can be attached to the stand in a state in which the first cushioning member is attached to the device main body and in an orientation in which the device main body has been laid down so that the display face is opposite an installation surface with the first cushioning member in between.

With the present disclosure, the television set includes a television device and a cushioning member. The television device includes a device main body and a stand. The device main body has a receiver for receiving television broadcasts, a display face for displaying television broadcasts received by the receiver, and an attachment component. The stand supports the device main body, and can be attached to and removed from the attachment component. The cushioning member is provided attachably to and removably from the device main body. The cushioning member includes a side wall component that covers a side face portion of the device main body corresponding to the attachment component of the device main body while exposing the attachment component. The television set is configured such that the stand can be attached to the attachment component exposed from the side wall component in a state in which the cushioning member is attached to the device main body and in an orientation in which the device main body has been laid down so that the display face is opposite an installation surface with the cushioning member in between.

With the present disclosure, the display device assembly method is an assembly method for a display device. The display device includes a device main body and a stand. The device main body has a display face and an attachment component to which the stand can be attached. The stand supports the device main body, and can be attached to and removed from the attachment component. The display device is housed in a packaging box along with a first cushioning member attached to the display face side of the device main body, and a second cushioning member attached to the rear face side of the device main body. The first cushioning member includes a side wall component that covers a side face portion of the device main body corresponding to the attachment component while exposing the attachment component of the device main body. The display device assembly method includes steps of taking the device main body out of the packaging box in a state in which the first cushioning member and the second cushioning member have been attached, and attaching the stand to the attachment component exposed from the side wall component of the first cushioning member in a state in which the first cushioning member is attached and in an orientation in which the device main body has been laid down so that the display face is opposite an installation surface with the first cushioning member in between.

With the present disclosure, as discussed above, a device can be adequately protected during assembly work.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A display device packaging structure comprising:
a first cushioning member configured to be detachably attached to a device main body of a display device, the first cushioning member including a bottom component that is configured to face with a display face of the device main body of the display device, a side wall component that is arranged relative to the bottom component such that the side wall component is configured to cover a side face portion of the device main body of the display device, and an access component that is disposed on the side wall component, with the access component being configured to expose an attachment component of the device main body of the display device such that a stand of the display device is attachable to the attachment component of the device main body of the display device through the access component while the first cushioning member is attached to the device main body of the display device.

2. The display device packaging structure according to claim 1, wherein
the access component has a recess that is disposed on the side wall component, the recess being arranged relative to the side wall component such that the recess is configured to expose the attachment component that is disposed on a bottom face of the device main body.

3. The display device packaging structure according to claim 2, wherein
the side wall component protrudes from the bottom component such that the side
wall component is configured to extend along substantially an entire length of the bottom face of the device main body, the side wall component having a smaller protrusion height at a portion where the recess is located than at a portion other than the portion where the recess is located.

4. The display device packaging structure according to claim 2, wherein
the side wall component has a smaller wall thickness at a portion where the recess is located than at a portion other than the portion where the recess is located.

5. The display device packaging structure according to claim 1, wherein
the bottom component includes a center part that is configured to cover a center of the display face of the device main body of the display device along substantially an entire length of the display face of the device main body of the display device along a center line extending in a first direction of the device main body of the display device.

6. The display device packaging structure according to claim 5, wherein
the bottom component further includes a plurality of holes at locations other than the center part, the bottom component being configured to cover the display face of the device main body of the display device.

7. The display device packaging structure according to claim 1, further comprising
a second cushioning member forming a rear cushioning component that is configured to be disposed on a rear face side of the device main body of the display device,
the first cushioning member forming a front cushioning component that is configured to be disposed on a display face side of the device main body, the front cushioning component having the side wall component, the front cushioning component being configured such that the stand of the display device is attachable to the attachment component of the device main body of the display device while the front cushioning component is attached to the device main body of the display device.

8. The display device packaging structure according to claim 1, wherein
the first cushioning member includes first and second cushioning components, the first cushioning component being configured to surround an upper part of the device main body of the display device from a display face side and a rear face side of the device main body of the display device, the second cushioning component being configured to be disposed on the display face side of a lower part of the device main body of the display device, the second cushioning component having the side wall component.

9. The display device packaging structure according to claim 8, further comprising
a second cushioning member including a third cushioning component that is configured to be disposed on the rear face side of the lower part of the device main body of the display device,
the first, second and third cushioning components being configured such that the stand of the display device is attachable to the attachment component of the device main body of the display device while the third cushioning component is removed from the device main body of the display device and the first and second cushioning components are attached to the device main body of the display device.

10. The display device packaging structure according to claim 1, wherein
the first cushioning member is configured to cover four sides of the device main body of the display device on the display face side of the device main body of the display device with the device main body of the display device having a substantially rectangular shape.

11. A television set comprising:
a television device including a device main body that has a receiver that is configured to receive television broadcasts, a display face that is configured to display the television broadcasts received by the receiver and an attachment component, and a stand that is detachably attached to the attachment component of the device main body such that the stand supports the device main body; and
a cushioning member detachably attached to the device main body of the television device, the cushioning member including a bottom component that faces with the display face of the device main body of the television device, a side wall component that is arranged to the bottom component such that the side wall component covers a side face portion of the device main body of the television device and an access component that is disposed on the side wall component, with the access component exposing the attachment component of the device main body of the television device such that the stand of the television device is attachable to the attachment component of the device main body of the television device through the access component while the cushioning member is attached to the device main body of the television device.

12. A display device assembly method comprising:
taking a device main body of a display device out of a packaging box with first, and second cushioning members that are detachably attached to the device main body of the display device, the first cushioning member including a bottom component that faces with a display face of the device main body of the display device, a side wall component that is arranged to the bottom component such that the side wall component covers a side face portion of the device main body of the display device and an access component that, is disposed on the side wall component, with the access component exposing an attachment component of the device main body of the display device;
placing the device main body of the display device on an installation surface such that, the display face of the device main body of the display device is opposite the installation surface with the first cushioning member in between; and
attaching a stand of the display device to the attachment component of the device main body of the display device through the access component of the first cushioning member while the first cushioning member is attached to the device main body of the display device.
